(19) United States
(12) Patent Application Publication
(10) Pub. No.: US 2010/0022218 A1
(43) Pub. Date: Jan. 28, 2010

(54) ADMINISTRATION AND SERVICE SYSTEM FOR WIRELESS TERMINAL DISPLAY DEVICES

(76) Inventor: Shih-Ming Chen, Hsinchu (TW)

Correspondence Address: SINORICA, LLC, 2275 Research Blvd., Suite 500, ROCKVILLE, MD, 20850, US

(21) Appl. No.: 12/201,016

(22) Filed: Aug. 29, 2008

(30) Foreign Application Priority Data
Jul. 22, 2008 (TW) 97127752

(51) Int. Cl. H04M 1/66

(52) U.S. Cl. 455/411

(57) ABSTRACT

An administration and service system for wireless terminal display devices comprises a digital supplier supplying digital images, digital video or digital music; an administration server including a user identity administration system, an authentication and authorization system and a digital content administration system, wherein the administration server exchanges digital data with the digital supplier and transmits the digital data; and a terminal display device, which is a digital electronic product communicating with the administration server via a wireless network and performing data transmission and identity administration. The wireless network is based on a Wi-Fi technology, and the terminal display device may be a digital photo frame. The primary objective of the present invention is to enable a user to administrate contents and transmit the contents to a wireless terminal display.

### BACKGROUND OF THE INVENTION

1. Field of the Invention

The present invention relates to an administration and service system, particularly to an administration and service system for wireless terminal display devices, which integrates wireless terminal display devices and a content administration and service platform, whereby a user can manage contents and transmit the contents to wireless terminal display devices.

2. Description of the Related Art

It is inconvenient for a user to store the images presented by a digital photo frame in a memory, such as a flash memory. Further, the user can neither far-end control or administrate the contents of the digital photo frame nor share the contents with others. At present, users have to watch and share contents on the website of a content administration platform. However, watching the contents of a website is troublesome for the persons who are unable to operate a computer or are not exactly using a computer.

Currently, the far-end digital photo frame control technologies have only two ends, i.e. the control end and the far-end digital photo frame, and lack an administration platform. For example, a Taiwan patent No.M320874 disclosed a digital photo frame, which can update its data synchronously with a far-end server, and which comprises a storage module, a network communication module and a data synchronization module. The network communication module communicates with a server wiredly or wirelessly. The data synchronization module can synchronously update the digital data of the storage module and the server. However, the prior art lacks an authorization approach. If the service platform has an administration and authentication function, the application of digital photo frames will be more diversified.

Accordingly, the present invention proposes a wireless terminal display device administration and service system to solve the conventional problem.

### SUMMARY OF THE INVENTION

The primary objective of the present invention is to provide an administration and service system for wireless terminal display devices, whereby a user can manage contents and transmit the contents to wireless terminal display devices.

Another objective of the present invention is to provide an administration and service system for wireless terminal display devices, which is a server platform having an administration and authentication function, and which is able to administrate terminal display devices and diversify the application of terminal display devices.

To achieve the abovementioned objectives, the present invention proposes an administration and service system for wireless terminal display devices, which comprises a digital supplier supplying digital images, digital video and digital music; an administration server including a user identity administration system, an authentication and authorization system and a digital content administration system, wherein the administration server exchanges digital data with the digital supplier and transmits the digital data; and a terminal display device, which is a digital electronic product communicating with the administration server via a wireless network and performing data transmission and identity administration. The wireless network is based on the Wi-Fi (Wireless Fidelity) technology. The terminal display device may be a digital photo frame, an IPTV (Internet Protocol Television), an IP (Internet Protocol) Camera, or a computer-related digital electronic product. In the first time that a user uses the terminal display device, the authentication and authorization system asks the terminal display device to identify a unique key and stores the unique key in the terminal display device, and then the unique key and a MAC (Media Access Control) address are transmitted to the administration server via a wireless network for registration. After registration, the administration server stores a feature of the terminal display device and creates a unique ID (identity), and the unique ID is sent back to the terminal display device. After the user acquires the unique ID, other MAC addresses become invalid, and a permanent relationship between the unique ID and a MAC address of the terminal display device is established. After the terminal display device is triggered and the unique ID is confirmed, the unique ID is transmitted via a wireless network to the administration server where the unique ID is to be verified by the user identity administration system. After the unique ID is verified by the user identity administration system, the administration server stores a status of the digital photo frame and sends the status to the terminal display device. A user can assign contents to a specified unique ID, and the administration server can send the assigned contents to the terminal display device. A user can transmit an audio/video file to a specified account number in the administration server via an electronic mail. The abovementioned digital supplier includes disc companies and audio/video businesses.

Below, the embodiments are described in detail in cooperation with the attached drawings to make easily understood the objectives, technical contents, features and accomplishments of the present invention.

### BRIEF DESCRIPTION OF THE DRAWINGS

FIG. 1 is a block diagram schematically showing the architecture of an administration and service system for wireless terminal display devices according to the present invention;

FIG. 2 is a block diagram schematically showing the operation of an authentication and authorization system according to the present invention; and

FIG. 3 is a block diagram schematically showing the operation of a user identity administration system according to the present invention.

### DETAILED DESCRIPTION OF THE INVENTION

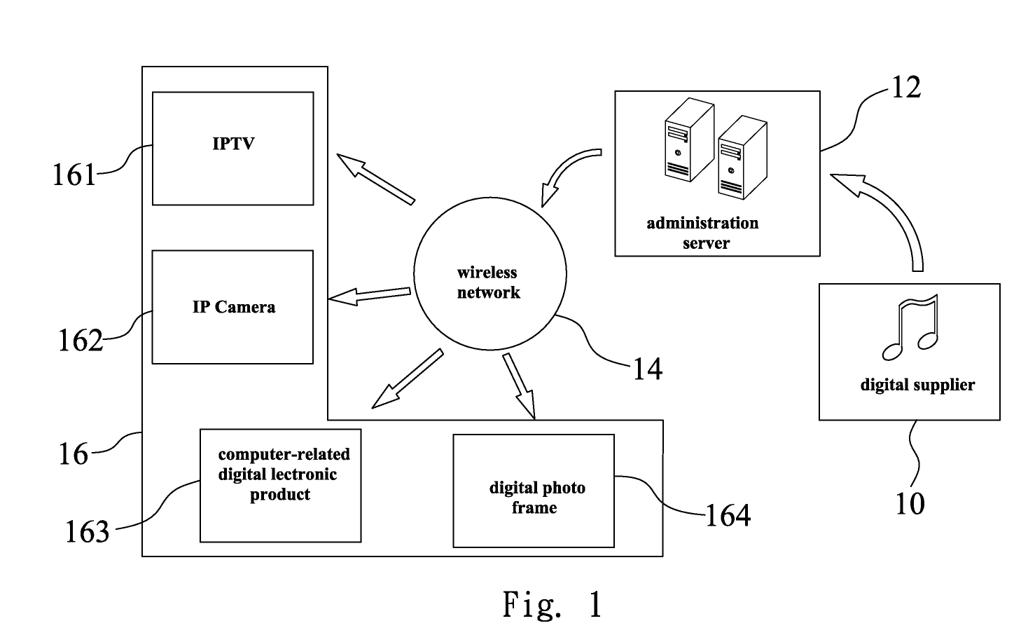

Refer to FIG. 1 a block diagram schematically showing the architecture of the present invention. The administration and service system for wireless terminal display devices of the present invention comprises a digital supplier 10, which is a disc company or A/V entertainment provider supplying digital images, digital video and digital music; an administration server 12 including a user identity administration system, an authentication and authorization system and a digital content administration system, wherein the administration server 12 exchanges digital data with the digital supplier 10 and transmits the digital data; and a terminal display device 16, which is a digital electronic product communicating with the administration server 12 via a wireless network 14 and performing data transmission and identity administration. The wireless network 14 is based on the Wi-Fi (Wireless Fidelity) technology. The terminal display device 16 may be an IPTV 161, an IP Camera 162, a computer-related digital electronic product 163, or a digital photo frame 164.

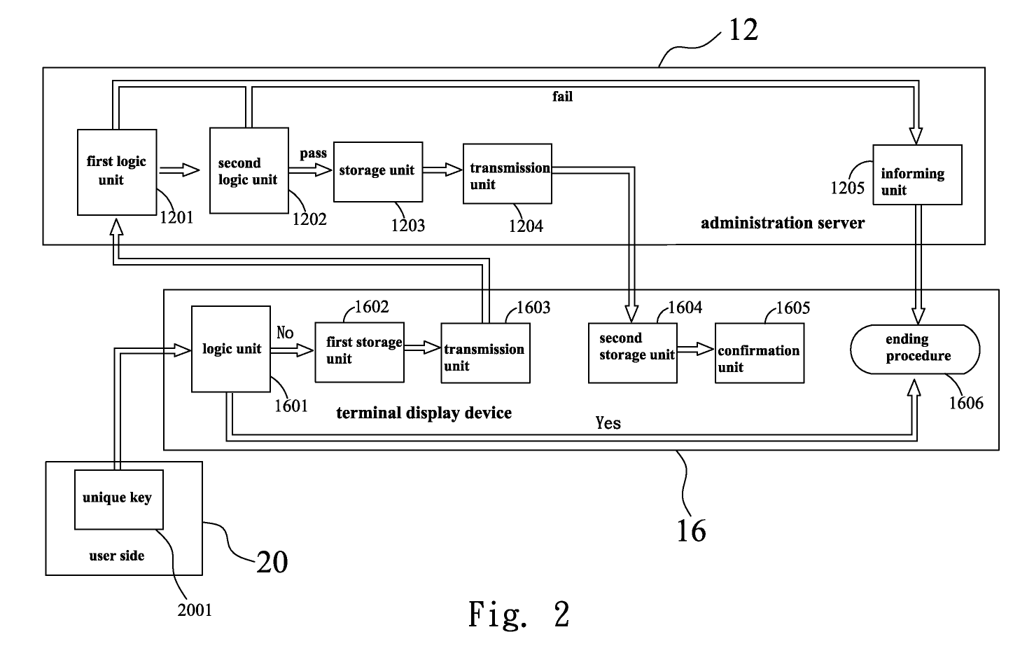

Refer to FIG. 2 a block diagram schematically showing the operation of the authentication and authorization system. A user side 20 has a unique key 2001. In the first time that a user uses the terminal display device 16, the authentication and authorization system asks the terminal display device 16 to identify the unique key 2001. After passing the identification by a logic unit 1601, the unique key 2001 is stored in a first storage unit 1602 of the terminal display device 16. Then, a transmission unit 1603 transmits the identified unique key 2001 and a MAC address to the administration server 12 via a wireless network for registration. The administration server 12 has a first logic unit 1201 and a second logic unit 1202 for registration. After registration, the feature of the terminal display device 16 is stored in a storage unit 1203, and a unique ID is created. The unique ID is sent back by a transmission unit 1204 to a second storage unit 1604 of the terminal display device 16 and then confirmed by a confirmation unit 1605. After the user acquires the unique ID, the other MAC addresses become invalid, and the permanent relationship between the unique ID and the MAC address of the terminal display device 16 is established. In the following logins, an ending procedure 1606 will be directly executed after the identified unique key 2001 has been confirmed by the logic unit 1601 of the terminal display device 16. If the unique key 2001 is determined to be invalid by the first and second logic units 1201 and 1202, the invalidation information is transmitted to an informing unit 1205, and the informing unit 1205 informs the ending procedure 1606 of the invalidation information.

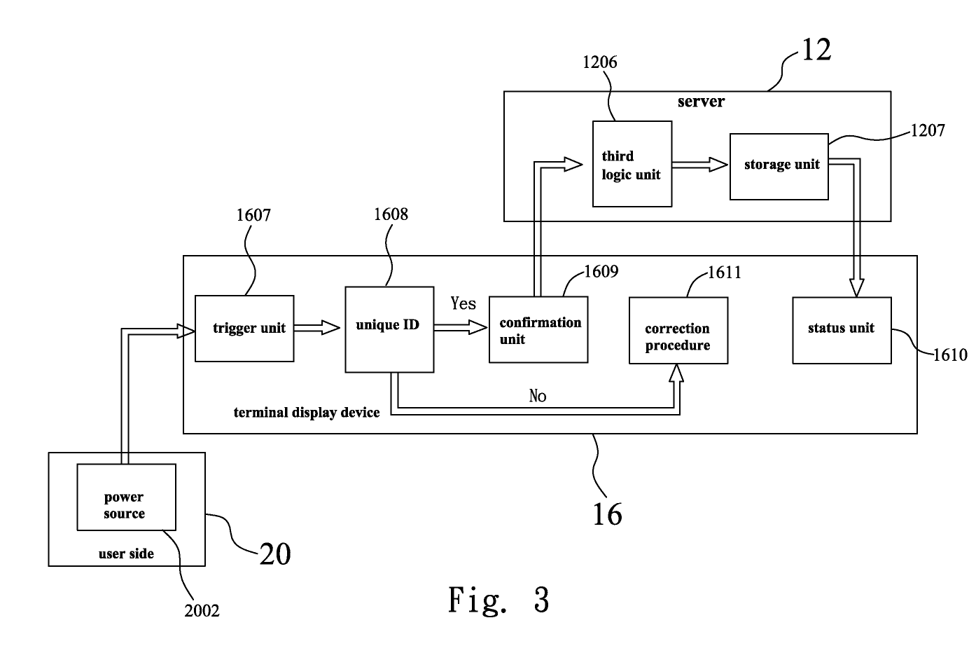

Refer to FIG. 3 a block diagram schematically showing the operation of the user identity administration system. The user side 20 has a power source 2002 providing power to trigger a trigger unit 1607 of the terminal display device 16. After a unique ID 1608 is confirmed by a confirmation unit 1609, the unique ID 1608 is transmitted via a wireless network to the administration server 12 where the unique ID 1608 is to be verified by the user identity administration system. Then, the unique ID 1608 is verified by a third logic unit 1206 of the administration server 12. After the unique ID 1608 is verified by the user identity administration system, the administration server 12 stores the status in a storage unit 1207 and sends the status to a status unit 1610 of the terminal display device 16 to change the status. When the unique ID 1608 is found to be invalid, the process proceeds to a correction procedure 1611. In the present invention, the user can assign contents to a specified unique ID, and the administration server 12 sends the assigned contents to the terminal display device 16.

The present invention integrates a Wi-Fi terminal display device and a content administration and service platform technology to enable content suppliers to administrate contents and transmit the contents to far-end Wi-Fi terminal display devices. The present invention can apply to the following fields:
1. General consumer market: Via the administration server, a user can upload photographs to let the far-end (overseas) parents or grandparents, who are unable to operate a computer, be able to see the latest photographs of the children instantly. Via the integrated information system, the related business can profit from the sale and service of digital photo frames. Such a type of business may attract customers from some specified groups, e.g. a group of classmates. If a group of classmates register in an administration server, they can watch the latest photographs of activities or daily living on wireless terminal display devices even though they are distributed everywhere.
2. Entertainment, culture and sport:
   A. Disc companies and A/V entertainment businesses can sell wireless digital photo frames to their members and update for the wireless digital photo frames the images of singers, actors and actresses, such as their photographs, MV (Music Video) and related activities. The novel business mode can create a new sale channel for the entertainment business.
   B. The museums can convert paintings into digital contents and provide the digital contents for the art-lovers.
   C. A business can cooperate with the Major League Baseball to provide the latest news of players for fans.
3. Security: Via the integration of IP cameras, an administration server and digital photo frames, a user can monitor the sites where the IP cameras are installed from the digital photo frames in any place where he can access the Internet.

The embodiments described above are only to exemplify the present invention to enable the persons skilled in the art to understand, make, and use the present invention. However, it is not intended to limit the scope of the present invention. Any equivalent modification or variation according to the shape, structure, feature or spirit disclosed in the present invention is to be also included with the scope of the present invention.

What is claimed is:

1. An administration and service system for wireless terminal display devices comprising
a digital supplier supplying digital images, digital video or digital music;
an administration server including a user identity administration system, an authentication and authorization system and a digital content administration system, wherein said administration server exchanges digital data with said digital supplier and transmits said digital data; and
a terminal display device, which is a digital electronic product communicating with said administration server via a wireless network and performing data transmission and identity administration.

2. The administration and service system for wireless terminal display devices according to claim 1, wherein said wireless network is based on a Wi-Fi (Wireless Fidelity) technology.

3. The administration and service system for wireless terminal display devices according to claim 1, wherein said terminal display device is a digital photo frame, an IPTV (Internet Protocol Television), an IP (Internet Protocol) Camera, or a computer-related digital electronic product.

4. The administration and service system for wireless terminal display devices according to claim 1, wherein when a user uses said terminal display device first time, said authentication and authorization system asks said terminal display device to identify a unique key and stores said unique key in said terminal display device, and then said unique key and a MAC (Media Access Control) address are transmitted to said administration server via a wireless network for registration.

5. The administration and service system for wireless terminal display devices according to claim 4, wherein after registration, said administration server stores a feature of said terminal display device and creates a unique ID.

6. The administration and service system for wireless terminal display devices according to claim 5, wherein after said user acquires said unique ID, another MAC address becomes invalid, and a permanent relationship between said unique ID and a MAC address of said terminal display device is established.

7. The administration and service system for wireless terminal display devices according to claim 6, wherein after said terminal display device is triggered and said unique ID is confirmed, said unique ID is transmitted via a wireless network to said administration server where said unique ID is to be verified by said user identity administration system.

8. The administration and service system for wireless terminal display devices according to claim 7, wherein after said unique ID is verified by said user identity administration system, said administration server stores a status of said terminal display device status and sends said status to said terminal display device.

9. The administration and service system for wireless terminal display devices according to claim 1, wherein a user assigns contents to a specified unique ID, and said administration server sends said contents to said terminal display device.

10. The administration and service system for wireless terminal display devices according to claim 1, wherein a user transmits an audio/video file to a specified account number in said administration server via an electronic mail.

11. The administration and service system for wireless terminal display devices according to claim 1, wherein said digital supplier includes disc companies and audio/video businesses.
